(19) United States
(12) Patent Application Publication
(10) Pub. No.: US 2011/0289689 A1
(43) Pub. Date: Dec. 1, 2011

(54) VISCO-ELASTIC BODY SUPPORT AND METHOD OF MANUFACTURING THE SAME

(76) Inventors: Tom D. Mikkelsen, Kingsport, TN (US); Chris Collins, Wise, VA (US)

(21) Appl. No.: 13/142,067

(22) PCT Filed: Dec. 21, 2009
(86) PCT No.: PCT/US09/69020

§ 371 Date: Aug. 17, 2011

Related U.S. Application Data
(60) Provisional application No. 61/140,643, filed on Dec. 24, 2008.

(51) Int. Cl. B68G 5/00

(52) U.S. Cl. 5/655.9

(57) ABSTRACT

A pillow assembly including a foam core having a top surface, side surface, and bottom surface, and an outer layer covering the top surface and side surface and leaving the bottom surface substantially exposed. The foam core has a higher hardness and a higher density than the outer layer. The foam core and the outer layer comprise reticulated or non-reticulated visco-elastic foam. The outer layer covers a majority of the foam core and has a substantially constant thickness across the top surface. The foam core includes a front side and a back side, both of which are covered by the outer layer and left and right sides of the foam core, which are exposed.

### CROSS-REFERENCE TO RELATED APPLICATIONS

Priority is hereby claimed to U.S. Provisional Patent App. No. 61/140,643, filed Dec. 24, 2008, the entire contents of which are herein incorporated by reference.

### BACKGROUND

Conventional body supports can be found in a wide variety of shapes and sizes, and are often adapted for supporting one or more body parts of a user. As used herein, the term “body support” includes without limitation any deformable element adapted to support one or more parts or all of a human or animal in any position. Examples of body supports include mattresses, pillows, and cushions of any type, including those for use in beds, seats, and in other applications.

Many body supports are constructed entirely or partially out of foam material. For example, polyurethane foam is commonly used in many mattresses, pillows, and cushions, and can be used alone or in combination with other types of cushion materials. In many body supports, visco-elastic foam material is used, providing the body support with an increased ability to conform to a user and to thereby distribute the weight or other load of the user. Some visco-elastic body support materials are also temperature sensitive, thereby also enabling the body support to change shape based in part upon the temperature of the supported body part.

In addition to the increasing use of visco-elastic foams in body supports, reticulated foams (both visco-elastic and non-visco-elastic) have also gained in popularity. Reticulated foams can provide added benefits of increased heat and moisture transfer due in large part to the relatively porous nature of reticulated foams. These characteristics are often highly desirable in body support applications of all types.

Although the number and types of body supports constructed with one or more layers of visco-elastic foam and reticulated foam (whether visco-elastic or otherwise) continue to increase, the capabilities of the foam materials in such body supports are often underutilized. In many cases, this underutilization is due to poor body support design.

Based at least in part upon the limitations of existing body supports and the high consumer demand for improved body supports in a wide variety of applications, new body supports continue to be welcome additions to the art.

### SUMMARY

Some embodiments of the present invention provide a body support comprising a body of visco-elastic foam having a cross-sectional shape, and a layer of visco-elastic foam enclosing at least a majority of the cross-sectional shape of the body. In some embodiments, the layer can entirely surround and enclose the cross-sectional shape of the body, and can even entirely surround the body on all sides. Either or both of the body of visco-elastic foam and the layer of visco-elastic foam can be reticulated or non-reticulated foam of any type desired. In some embodiments, the visco-elastic foam of the body has different characteristics (e.g., density, firmness, temperature sensitivity, and the like) than the visco-elastic foam of the layer.

A pillow assembly including a foam core having a top surface, side surface, and bottom surface, and an outer layer covering the top surface and side surface and leaving the bottom surface substantially exposed. The foam core has a higher hardness and a higher density than the outer layer. The foam core and the outer layer comprise reticulated or non-reticulated visco-elastic foam. The outer layer covers a majority of the foam core and has a substantially constant thickness across the top surface. The foam core includes a front side and a back side, both of which are covered by the outer layer and left and right sides of the foam core, which are exposed.

A pillow assembly including a foam core having a top surface, a first side surface, a second side surface, and bottom surface, and an outer layer covering the top surface and the first side surface and having a substantially constant thickness across the top surface. The foam core has a higher hardness and a higher density than the outer layer. The foam core comprises reticulated or non-reticulated visco-elastic foam. The outer layer covers a majority of the foam core. The foam core further includes a third side surface and a fourth side surface, such that the third side surface is covered by the outer layer and the second and fourth side surfaces are exposed.

Further aspects of the present invention, together with the organization and operation thereof, will become apparent from the following detailed description of the invention when taken in conjunction with the accompanying drawings, wherein like elements have like numerals throughout the drawings.

### BRIEF DESCRIPTION OF THE DRAWINGS

FIG. 1 is a side elevational view of a pillow according to an embodiment of the present invention.

FIG. 2 is a partially sectioned perspective view of the pillow shown in FIG. 1.

FIG. 3 is a perspective view of a pillow according to another embodiment of the present invention.

FIG. 4 is a cross-sectional view of the pillow illustrated in FIG. 3, taken along lines 4-4 of FIG. 3.

FIG. 5 is a perspective view of a pillow according to another embodiment of the present invention;

FIG. 6 is a cross-sectional view of the pillow illustrated in FIG. 5, taken along lines 6-6 of FIG. 5.

### DETAILED DESCRIPTION

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, terms such as “first”, “second”, and “third” are used herein and in the appended claims for purposes of description and are not intended to indicate or imply relative importance or significance. The term “first” does not necessarily refer to the top most layer, rather, it refers to the first of a plurality, without indicating a particular location or position. Similarly, the terms “top” and “bottom” are used for the purpose of description and are not intended to indicate or imply relative importance, significance, unless otherwise specified. The term “top” does not necessarily refer to the top most layer, and “bottom” does not necessarily refer to the bottom most layer.

The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “collected” and “coupled” and variations thereof are not restricted to physical or mechanical connections or couplings.

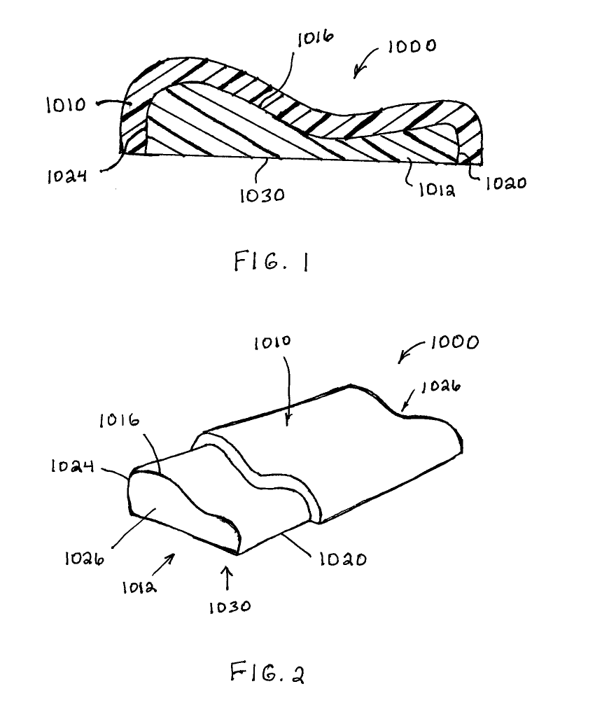

A body support according to a first embodiment of the present invention is illustrated in FIGS. 1-2. The illustrated body support is a pillow 1000 having a contoured shape. However, the body support can be a pillow 1000 having any other shape desired.

The pillow 1000 shown in FIGS. 1 and 2 comprises two layers of material: an outer or top layer 1010 comprising reticulated or non-reticulated visco-elastic foam of any type (sometimes referred to as “memory foam” or “low resilience foam”), and a foam core or bottom layer 1012 comprising reticulated or non-reticulated visco-elastic foam of any type. In other words, the pillow 1000 includes a body of foam (e.g., bottom layer 1012) at least partially enclosed by a layer of foam (e.g., top layer 1010).

The top and bottom layers 1010, 1012 can be secured to one another by adhesive or cohesive bonding material, by being bonded together during formation of the top and bottom layers 1010, 1012, by molding the top layer 1010 about the bottom layer 1012, by tape, hook and loop fastener material, or conventional fasteners, by stitches extending at least partially through the top and bottom layers 1010, 1012, or in any other suitable manner. Subject to the manners of connection just described, the top and bottom layers 1010, 1012 can be manufactured by molding foam into the illustrated shapes, by cutting or performing other machining operations on blocks or other pieces of foam to produce the illustrated shapes, or in any other suitable manner.

As shown in FIGS. 1 and 2, the first outer layer 1010 covers a top 1016, a front side 1020, and a back side 1024 of the foam core bottom layer 1012, while leaving the sides 1026 and bottom surface 1030 of the bottom layer 1012 uncovered. In other embodiments, the outer or top layer 1010 can cover any portion or all portions of the bottom layer 1012.

In some embodiments, a body of visco-elastic foam is at least partially enclosed by a layer of visco-elastic foam, wherein the body of visco-elastic foam has a cross-sectional shape (e.g., similar to the shape shown in FIG. 1, for example) in which the layer of visco-elastic foam surrounds at least a majority (i.e., over 50%) of the body of visco-elastic foam. The layer need not necessarily have a uniform thickness about the body, and the body can have any shape and size desired. Also, despite the fact that the layer extends about at least a majority of the body of visco-elastic foam in the cross-section of the visco-elastic body, the layer need not necessarily extend about the body in other cross-sections of the visco-elastic body (e.g., in a cross-section of the pillow 1000 shown in FIGS. 1 and 2 taken into and out of the plane of the page of FIG. 1, the top layer 1010 does not extend about a majority of the bottom layer 1012).

In some embodiments, the top layer 1010 provides a relatively soft and comfortable surface for a user's body or body portion (hereinafter referred to as “body”). Coupled with the slow recovery characteristic of the visco-elastic foam, the top layer 1010 can also conform to a user's body, thereby distributing the force applied by the user's body upon the top layer 1010. In some embodiments, the top layer 1010 has a hardness of at least about 30 N and no greater than about 175 N for desirable softness and body-conforming qualities. In other embodiments, a top layer 1010 having a hardness of at least about 40 N and no greater than about 110 N is utilized for this purpose. In still other embodiments, a top layer 1010 having a hardness of at least about 40 N and no greater than about 75 N is utilized. Unless otherwise specified, the hardness of a material referred to herein is measured by exerting pressure from a plate against a sample of the material having length and width dimensions of 40 cm each (defining a surface area of the sample of material), and a thickness of 5 cm to a compression of 40% of an original thickness of the material at approximately room temperature (e.g., 21-23 degrees Celsius), wherein the 40% compression is held for a set period of time, following the International Organization of Standardization (ISO) 2439 hardness measuring standard.

The top layer 1010 can also have a density providing a relatively high degree of material durability. The density of the visco-elastic foam in the top layer 1010 can also impact other characteristics of the foam, such as the manner in which the top layer 1010 responds to pressure, and the feel of the foam. In some embodiments, the visco-elastic foam of the top layer 1010 has a density of no less than about 30 kg/m³ and no greater than about 150 kg/m³. In other embodiments, the visco-elastic foam of the top layer 110 has a density of at least about 40 kg/m³ and no greater than about 125 kg/m³. In still other embodiments, the visco-elastic foam of the top layer 1010 has a density of at least about 60 kg/m³ and no greater than about 115 kg/m³.

The visco-elastic foam of the top layer 1010 can be selected for responsiveness to any range of temperatures. However, in some embodiments, a temperature responsiveness in a range of a user's body temperatures (or in a range of temperatures to which the pillow 1000 is exposed by contact or proximity to a user's body resting thereon) can provide significant advantages. For example, a visco-elastic foam selected for the top layer 1010 can be responsive to temperature changes within a range of at least about 10° C. In still other embodiments, the visco-elastic foam selected for the top layer 1010 can be responsive to temperature changes within a range of at least about 15° C.

As used herein, a material is considered “responsive” to temperature changes if the material exhibits a change in hardness of at least 10% measured by ISO Standard 3386 through the range of temperatures between 10 and 30 degrees Celsius.

As noted above, the top layer 1010 can be manufactured of reticulated visco-elastic foam. Reticulated visco-elastic foam has a structure that is significantly different than that of non-reticulated visco-elastic foam, and can therefore provide body supports with significantly different properties as will now be described.

Reticulated foam (visco-elastic or otherwise) is a cellular foam structure in which the cells of the foam are essentially skeletal. In other words, the cells of the reticulated foam are each defined by a plurality of apertured windows surrounded by cell struts. The cell windows of reticulated foam can be entirely gone (leaving only the cell struts) or substantially gone. In some embodiments, the foam is considered “reticulated” if at least 50% of the windows of the cells are missing (i.e., windows having apertures therethrough, or windows that are completely missing and therefore leaving only the cell struts). Such structures can be created by destruction or other removal of cell window material, or preventing the complete formation of cell windows during the manufacturing process of the foam.

By virtue of the skeletal cellular structure of reticulated visco-elastic foam, heat in the top layer 1010 can be transferred away from the source of heat (e.g., a user's body), thereby helping to prevent one or more areas of the top layer 1010 from reaching an undesirably high temperature. Also, the reticulated structure of the visco-elastic foam in the top layer 1010 enables significantly higher airflow into, out of, and through the top layer 1010—a characteristic of the top layer 1010 that can reduce heat in the top layer. Furthermore, reticulated foam can perform a wicking function to draw moisture away from the surface of the pillow 1000 to an interior location of the pillow 1000, thereby increasing user comfort. At the same time, the visco-elastic nature of the reticulated visco-elastic foam in the top layer 1010 provides desirable tactile contact and pressure responsiveness for user comfort, as well as the attractive body-conforming qualities of visco-elastic foam. In this regard, the reticulated visco-elastic foam of some embodiments has a reduced hardness level, thereby providing a relatively soft and comfortable surface for a user's body. In conjunction with the slow recovery characteristic of the reticulated visco-elastic material, the top layer 1010 can also at least partially conform to the user's body, thereby distributing the force applied by the user's body upon the top layer 1010.

In those embodiments in which the top layer 1010 is manufactured of reticulated visco-elastic foam (as opposed to non-reticulated visco-elastic foam as described earlier), the top layer 1010 of reticulated visco-elastic foam can have a hardness of at least about 20 N and no greater than about 150 N for desirable softness and pressure-responsive qualities. In other embodiments, a reticulated visco-elastic foam top layer 1010 having a hardness of at least about 30 N and no greater than about 100 N is utilized for this purpose. In still other embodiments, reticulated visco-elastic foam top layer 1010 having a hardness of at least about 40 N and no greater than about 85 N is utilized.

The top layer 1010 of reticulated visco-elastic foam can also have a density providing a relatively high degree of material durability. The density of reticulated visco-elastic foam in the top layer 1010 can also impact other characteristics of the foam, such as the manner in which the top layer 1010 responds to pressure, and the feel of the foam. In some embodiments, the top layer has a reticulated foam with a density of no less than about 30 kg/m³ and no greater than about 175 kg/m³. In other embodiments, a reticulated visco-elastic foam top layer 1010 having a density of at least about 50 kg/m³ and no greater than about 130 kg/m³ is utilized. In still other embodiments, a reticulated visco-elastic foam top layer 1010 having a density of at least about 60 kg/m³ and no greater than about 110 kg/m³ is utilized.

Reticulated visco-elastic foam of the top layer 1010 can be selected for responsiveness (as defined above) to any range of temperatures, including those described above in connection with non-reticulated visco-elastic foam of the top layer 1010.

As described above, the bottom layer 1012 of the pillow 1000 illustrated in FIGS. 1 and 2 comprises a cellular structure of reticulated or non-reticulated visco-elastic foam. This layer of visco-elastic foam can be a supportive layer providing a relatively stiff but flexible and resilient substrate upon which the top layer 1010 lies. However, by virtue of the visco-elastic foam used for the bottom layer 1012, the resiliently deformable nature of the bottom layer 1012 can still provide a degree of user comfort (to the extent that the user's weight affects the shape of the bottom layer 1012). The visco-elastic foam of the bottom layer 1012 can be more resilient than that of the top layer 1010, and in some embodiments has a hardness of at least about 50 N and no greater than about 300 N for a desirable degree of support and comfort. In other embodiments, the visco-elastic foam bottom layer 1012 has a hardness of at least about 80 N and no greater than about 250 N for this purpose. In still other embodiments, the visco-elastic foam bottom layer 1012 has a hardness of at least about 90 N and no greater than about 180 N.

Depending at least in part upon the thickness and material properties of the top layer 1010, in some embodiments the bottom layer 1012 can be exposed to substantial body heat from a user resting upon the pillow 1000. In such embodiments, the visco-elastic foam of the bottom layer 1012 can be selected to be substantially insensitive to temperature changes (as defined above), thereby retaining the supportive properties desired for the bottom layer 1012 throughout a range of body temperatures to which the bottom layer 1012 may be exposed. In some embodiments, the bottom layer 1012 can comprise visco-elastic foam that is substantially insensitive to temperature changes at least within a range of about 15° C. to about 30° C. In still other embodiments, a bottom layer 1012 of visco-elastic foam that is substantially insensitive to temperature changes within a range of about 15° C. to about 25° C. can be used.

By using reticulated visco-elastic foam for the top layer 1010, an additional degree of ventilation, heat dissipation, and/or moisture wicking can be provided to the top surface 1016 of the top layer 1010, can help dissipate heat within the pillow 1000, and can therefore help to reduce heat in one or more locations of the pillow 1000.

Like the top layer 1010 of the pillow 1000, the bottom layer 1012 can have a density providing a relatively high degree of material durability. As described above (in connection with the visco-elastic foam of the top layer), the density of the visco-elastic foam in the bottom layer 1012 can impact other characteristics of the foam, such as the manner in which the bottom layer 1012 responds to pressure, and the feel of the foam. In some embodiments, the bottom layer 1012 has any visco-elastic from density falling within the density ranges described above in connection with the top layer 1010.

The pillow 1000 illustrated in FIGS. 1 and 2 can provide support for a user while still conforming to a user's body (e.g., head and neck) based upon the visco-elastic nature of the body support material. Accordingly, the visco-elastic material of the pillow 1000 can distribute pressure from the user's body across the surface of the pillow 1000, thereby potentially reducing stress upon the user's neck and/or reducing pressure upon the user's face or other area of the user's head in contact with the pillow 1000. In those embodiments in which the visco-elastic foam is temperature-sensitive as described above, the shape of the pillow 1000 can also be adapted to the user based upon the user's body heat. Also, in those embodiments in which the first and/or second layers are manufactured from reticulated visco-elastic foam, such foam can provide an increased amount of ventilation, heat dissipation, and/or moisture wicking based upon the skeletal cellular structure of the foam.

As described above, the top layer 1010 of the pillow shown in FIGS. 1 and 2 encloses at least a majority of the bottom layer 1012 in a cross-section of the pillow 1000. By virtue of this construction, the user can be substantially shielded from contact or pressure against the bottom layer 1012 (which can be firmer and have other properties that are significantly different from the visco-elastic foam of the top layer 1010) in use of the pillow 1000. Also, this pillow construction can capitalize upon manufacturing processes that can greatly simplify the production and/or lower the cost of the pillow 1000. For example, bottom layer 1012 can be produced in any conventional manner, after which time visco-elastic foam can be formed (e.g., in a molding operation) about the bottom layer 1012 to produce the top layer 1010. As another example, the top layer 1010 can be produced in any conventional manner, after which time visco-elastic foam can be formed (e.g., in a molding operation) within a cavity of the top layer 1010 to produce the bottom layer 1012. It will be appreciated that in some cases, the relationship between the top and bottom layers 1010, 1012 as described above can greatly assist in securing and retaining the top and bottom layers together and in a desired positional relationship—both during manufacture of the pillow 1000 and afterwards.

Although the body support illustrated in FIGS. 1 and 2 is a pillow 1000, it should be noted that any of the features and elements described and/or illustrated herein apply equally to any other type of body support having any shape and size. In this regard, the manufacturing advantages associated with the features of the pillow 1000 described above can be realized in the production of other types of body supports, including without limitation mattresses, mattress toppers, sleeper sofas, overlays, futons, head pillows, seat cushions, seat backs, neck pillows, leg spacer pillows, eye masks, and other body supports adapted to support part or all of a human or animal body.

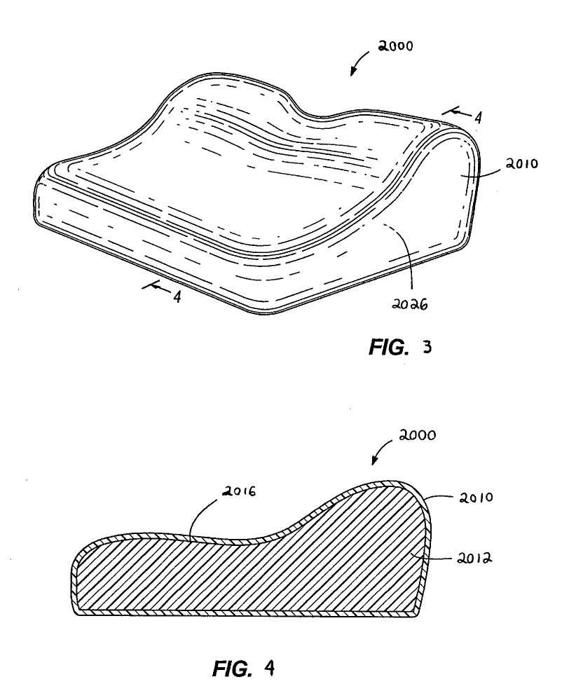

FIGS. 3 and 4 illustrate another embodiment of a body support according to the present invention. This embodiment employs much of the same structure and has many of the same properties as the embodiments of the body support described above in connection with FIGS. 1 and 2. Accordingly, the following description focuses primarily upon the structure and features that are different than the embodiments described above in connection with FIGS. 1 and 2. Reference should be made to the description above in connection with FIGS. 1 and 2 for additional information regarding the structure and features, and possible alternatives to the structure and features of the body support illustrated in FIGS. 3 and 4 and described below. Structure and features of the embodiment shown in FIGS. 3 and 4 that correspond to structure and features of the embodiment of FIGS. 1 and 2 are designated hereinafter in the 2000 series of reference numbers.

As described above, the features, elements, and methods of the present invention are applicable to body supports having any shape and size and adapted for any body support application. The pillow 2000 illustrated in FIGS. 3 and 4 has a first layer 2010 of visco-elastic foam and a second layer 2012 of visco-elastic foam. However, the first layer 2010 of visco-elastic foam illustrated in FIGS. 3 and 4 encloses the second layer 2012 of visco-elastic foam. In other embodiments, the first layer 2010 can cover any portion (e.g., less than all) of the second layer 2012, such as only the top 2016 and sides 2026 of the second layer 2012, only the top 2016 of the second layer 2012, and the like.

As described above in connection with the embodiment of FIGS. 1 and 2, the first and second layers 2010, 2012 can both be manufactured from non-reticulated visco-elastic foam or reticulated visco-elastic foam. As was also the case with the embodiment of FIGS. 1 and 2, the first layer 2010 can be manufactured from non-reticulated visco-elastic foam while the second layer 2012 can be manufactured from reticulated visco-elastic foam (or vice-versa). For example, in those embodiments in which the first layer 2010 is manufactured of reticulated visco-elastic foam, enhanced ventilation and/or heat and moisture dissipation for the second layer 2012 of non-reticulated visco-elastic foam can be provided (due at least in part to the skeletal cellular structure of the reticulated foam of the first layer 2010 in such embodiments), while still providing a relatively soft and comfortable surface of the pillow 2000 and the desirable body-conforming and pressure distributing properties for the user's body by virtue of the visco-elastic nature of the first layer 2010. As another example, in those embodiments in which the first layer 2010 is manufactured of non-reticulated visco-elastic foam, a reticulated cellular structure of the second layer 2012 can provide improved ventilation at the surface of the pillow 2000.

As discussed earlier, the visco-elastic material of the first and second layers 2010, 2012 can provide the same desirable softness and body-conforming features described above in connection with the illustrated embodiment of FIGS. 1 and 2.

In other embodiments, the first layer 2010 of the body support 2000 illustrated in FIGS. 3 and 4 comprises reticulated non-visco-elastic foam (rather than reticulated visco-elastic foam). In such embodiments, the reticulated non-visco-elastic foam of the first layer 2010 can provide a degree of support while still retaining the heat-dissipative and/or ventilating properties described above due to the reticulated cellular structure of the first layer 2010. A pillow 2000 having such a construction can also have significant softness and body conforming properties, based at least in part upon the non-reticulated visco-elastic foam in the second layer 2012.

In still other embodiments, the first layer 2010 of the body support 2000 illustrated in FIGS. 3 and 4 can instead comprise visco-elastic foam, while the second layer 2012 can comprise reticulated non-visco-elastic foam. In such embodiments, the reticulated non-visco-elastic foam of the second layer can provide an enhanced degree of support while still retaining the heat-dissipative and/or ventilating properties described above due to the reticulated cellular structure of the second layer 2012. Also, a pillow 2000 having such a construction can have significant softness and body conforming properties, based upon the visco-elastic foam in the first layer 2010.

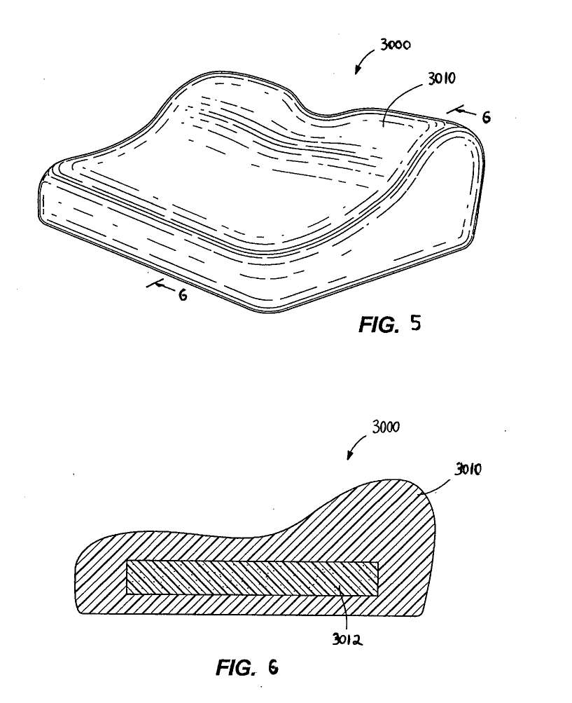

FIGS. 5 and 6 illustrate another embodiment of a body support according to the present invention. This embodiment employs much of the same structure and has many of the same properties as the embodiments of the body support described above in connection with FIGS. 1-4. Accordingly, the following description focuses primarily upon the structure and features that are different than the embodiments described above in connection with FIGS. 1-4. Reference should be made to the description above in connection with FIGS. 1-4 for additional information regarding the structure and features, and possible alternatives to the structure and features of the body support illustrated in FIGS. 7 and 8 and described below. Structure and features of the embodiment shown in FIGS. 7 and 8 that correspond to structure and features of the embodiment of FIGS. 1-4 are designated hereinafter in the 3000 series of reference numbers.

Like the pillow 2000 illustrated in FIGS. 3 and 4, the pillow 3000 illustrated in FIGS. 7 and 8 has a first layer 3010 of reticulated or non-reticulated visco-elastic foam and a second layer 3012 of reticulated or non-reticulated visco-elastic foam. The second layer 3012 can be partially or fully enclosed within the material of the first layer 3010, and can have any shape and size desired. By way of example only, the second layer 3012 illustrated in FIG. 6 is substantially block-shaped, and is relatively thick and elongated.

The pillow 3000 can be manufactured in any manner desired. In some embodiments, the pillow 3000 is manufactured by molding the first layer 3010 of visco-elastic foam over the second layer 3012 of visco-elastic foam. In such embodiments, the second layer 3012 can be an insert within a mold about which the visco-elastic foam of the first layer 3010 is formed. It will be appreciated that other manners of manufacturing the pillow 3000 with an insert comprising visco-elastic foam are possible, and fall within the spirit and scope of the present invention.

In those embodiments of the present invention disclosed herein having one or more layers of materials, it should be noted that any layer can itself be defined by one or more “sub-layers” of the same type of material (e.g., reticulated or non-reticulated visco-elastic foam). In this regard, any of the layers can be defined by any number of such sub-layers. Also, the sub-layers in each layer can have the same or different thickness, and can have any of the layer shapes, surface profiles, or other features described and illustrated herein.

Any of the body supports disclosed herein can have one or more covers at least partially enclosing one or more of the body support layers. Each cover can fully or partially enclose a single layer of the body support, or two or more layers of the body support, as desired. Also, each cover can cover any or all surfaces of one or more layers, such as the top of a layer, the top and sides of a layer, one or more sides of a layer or adjacent layers, and the like. Also, the body support can comprise two covers: a first cover at least partially enclosing one layer of the body support and a second cover at least partially enclosing another layer of the body support.

The covers can comprise any sheet material desired, including without limitation any synthetic and/or natural fabric or cloth material, such as cotton, polyester, a cotton/polyester blend, wool, visco-elastic or non-visco-elastic foam sheeting, and the like, and can be made of the same or different materials. In some embodiments, each cover can have one or more seams. Depending at least in part upon the type of cover material utilized, the seams can be attached by adhesive or cohesive bonding material, double-sided tape, stitching, hot-melting, conventional fasteners (e.g., zippers, buttons, clasps, laces, hook and loop fastener material, hook and eye sets, tied ribbons, strings, cords, or other similar elements, and the like), by being molded together in one or more manufacturing processes, or in any other suitable manner.

Any covers used can be secured permanently to and/or about the layers which the covers at least partially enclose. In some embodiments, the covers are removable from such layers, such as by being shaped to slip onto and off of the layers, by one or more releasable fasteners (e.g., zippers, buttons, clasps, laces, hook and loop fastener material pieces, hook and eye sets, tied ribbons, strings, cords, or other similar elements), and the like. Any such fasteners can be positioned to releasably secure at least one portion of a cover to another portion of the same or different cover and/or to an adjacent layer. For example, the top cover can have a zippered slot through which the top and middle layers of the body support can be moved to install and remove the top cover.

Although particular constructions embodying independent aspects of the present invention have been shown and described, other alternative constructions will become apparent to those skilled in the art and are within the intended scope of the independent aspects of the present invention. Various features and advantages of the invention are set forth in the following claims.

1. A pillow assembly comprising:
a foam core having a top surface, side surface, and bottom surface; and
an outer layer covering the top surface and side surface and leaving the bottom surface substantially exposed.

2. A pillow assembly as defined in claim 1, wherein the foam core has a higher hardness than the outer layer.

3. A pillow assembly as defined in claim 1, wherein the foam core has a higher density than the outer layer.

4. A pillow assembly as defined in claim 1, wherein the foam core comprises visco-elastic foam.

5. A pillow assembly as defined in claim 1, wherein the foam core comprises reticulated foam.

6. A pillow assembly as defined in claim 1, wherein the outer layer has a substantially constant thickness across the top surface.

7. A pillow assembly as defined in claim 1, wherein the outer layer comprises visco-elastic foam.

8. A pillow assembly as defined in claim 1, wherein the outer layer comprises a reticulated foam.

9. A pillow assembly as defined in claim 1, wherein the outer layer covers a majority of the foam core.

10. A pillow assembly as defined in claim 1, wherein the side of the foam core includes a front side and a back side, such that the front side and the back side are covered by the outer layer and wherein left and right sides of the foam core are exposed.

11. A pillow assembly comprising:
a foam core having a top surface, a first side surface, a second side surface, and bottom surface; and
an outer layer covering the top surface and the first side surface and having a substantially constant thickness across the top surface.

12. A pillow assembly as defined in claim 11, wherein the foam core has a higher hardness than the outer layer.

13. A pillow assembly as defined in claim 11, wherein the foam core has a higher density than the outer layer.

14. A pillow assembly as defined in claim 11, wherein the foam core comprises visco-elastic foam.

15. A pillow assembly as defined in claim 11, wherein the foam core comprises reticulated foam.

16. A pillow assembly as defined in claim 11, wherein the outer layer has a substantially constant thickness across the top surface.

17. A pillow assembly as defined in claim 11, wherein the outer layer comprises visco-elastic foam.

18. A pillow assembly as defined in claim 11, wherein the outer layer comprises reticulated foam.

19. A pillow assembly as defined in claim 11, further comprising a third side surface and a fourth side surface, such that the third side surface is covered by the outer layer and the second and fourth side surfaces are exposed.

20. A pillow assembly as defined in claim 11, wherein the outer layer covers a majority of the foam core.
